(19) United States
(12) Patent Application Publication
(10) Pub. No.: US 2024/0425137 A1
(43) Pub. Date: Dec. 26, 2024

(54) STRADDLE TYPE VEHICLE

(71) Applicant: KAWASAKI MOTORS, LTD., Akashi-shi (JP)

(72) Inventors: Masato KOGIRIMA, Akashi-shi (JP); Kohei KAWAKAMI, Akashi-shi (JP)

(21) Appl. No.: 18/750,700

(22) Filed: Jun. 21, 2024

(30) Foreign Application Priority Data
Jun. 26, 2023 (JP) 2023-104036

(51) Int. Cl. B62K 11/10

(52) U.S. Cl. CPC B62K 11/10; B62K 2204/00

(57) ABSTRACT

There is provided a straddle type vehicle including: a front wheel and a rear wheel; a body frame rotatably supporting the front wheel and the rear wheel; and a pair of left and right steps supported by the body frame. The steps each include a base end portion attached to the body frame without rotating about an axis extending in a left-right direction of the body frame, and a step main body portion having a footrest surface configured to support feet of a rider. The step main body portion extends outward in the left-right direction from the base end portion, and is coupled to the base end portion in a state of being rotatable about the axis extending in the left-right direction.

### CROSS-REFERENCE TO RELATED APPLICATIONS

This application is based on and claims priority under 35 USC 119 from Japanese Patent Application No. 2023-104036 filed on Jun. 26, 2023, the contents of which are incorporated herein by reference.

### TECHNICAL FIELD

The present disclosure relates to a straddle type vehicle.

### BACKGROUND ART

A straddle type vehicle that does not have a crank mechanism and can travel while kicking the ground is known. For example, US2015-0130150A below discloses a straddle type vehicle for children configured to travel by kicking the ground while a child keeps balance.

In the straddle type vehicle of US2015-0130150A, a member for supporting the feet of a rider is not provided, the rider often has to lift his or her feet off the ground. Therefore, the straddle type vehicle of US2015-0130150A has room for improvement in terms of ride comfort.

### SUMMARY OF INVENTION

The present disclosure provides a straddle type vehicle that can support the feet of a rider and improve ride comfort.

According to an illustrative aspect of the present disclosure, a straddle type vehicle includes: a front wheel and a rear wheel; a body frame rotatably supporting the front wheel and the rear wheel; and a pair of left and right steps supported by the body frame. The steps each include a base end portion attached to the body frame without rotating about an axis extending in a left-right direction of the body frame, and a step main body portion having a footrest surface configured to support feet of a rider. The step main body portion extends outward in the left-right direction from the base end portion, and is coupled to the base end portion in a state of being rotatable about the axis extending in the left-right direction.

According to the straddle type vehicle of the present disclosure, the feet of a rider can be stably supported, and the ride comfort can be further improved.

### BRIEF DESCRIPTION OF DRAWINGS

FIG. 1 is a schematic side view of a straddle type vehicle according to a first embodiment of the present disclosure.

FIG. 2 is a schematic plan view of the straddle type vehicle shown in FIG. 1.

FIG. 3 is a schematic rear view of the straddle type vehicle shown in FIG. 1.

FIG. 4 is an enlarged view of a part of FIG. 1.

FIG. 5 is a view in which a main body of a step is omitted from FIG. 4.

FIG. 6 is a view showing a part of a cross section taken along a line VI-VI of FIG. 4.

FIG. 7 is a view showing a part of a cross section taken along a line VII-VII of FIG. 4.

FIG. 8 is a view of the vicinity of a rear end portion of a main frame as viewed diagonally from the rear left.

FIG. 9 is a view of the vicinity of the rear end portion of the main frame as viewed diagonally from the lower right.

### DESCRIPTION OF EMBODIMENTS

Hereinafter, a first embodiment of the present disclosure will be described with reference to the drawings.

### (Overall Configuration)

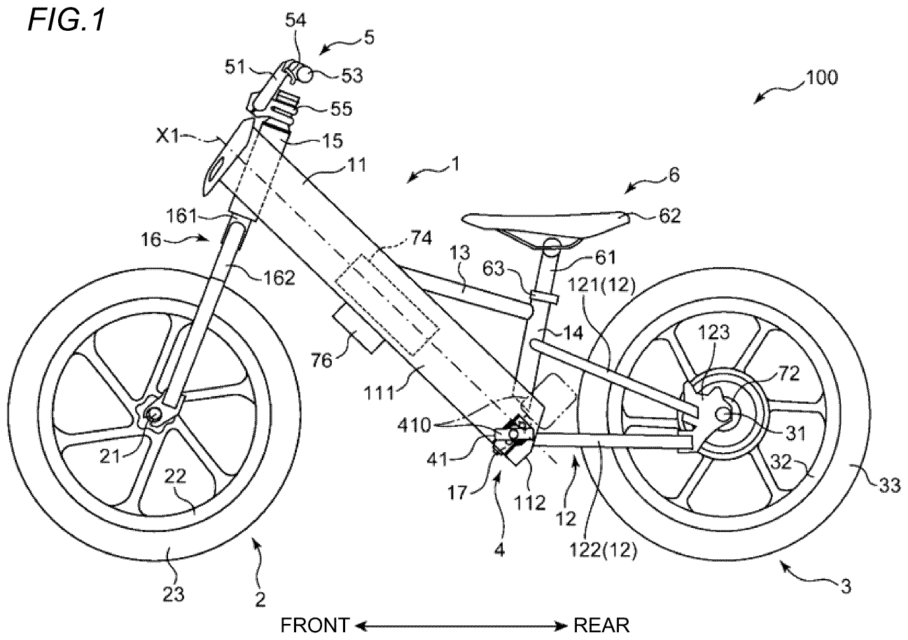

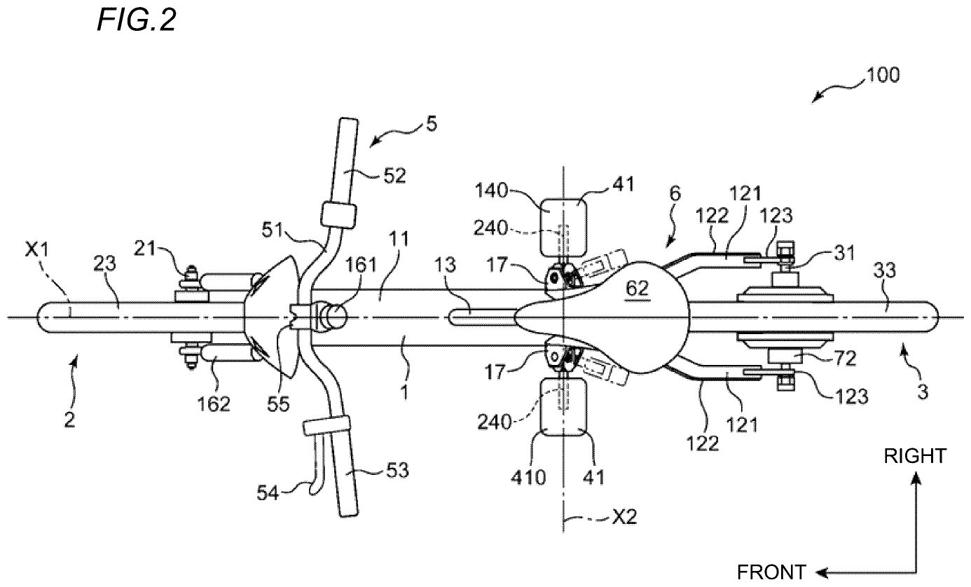

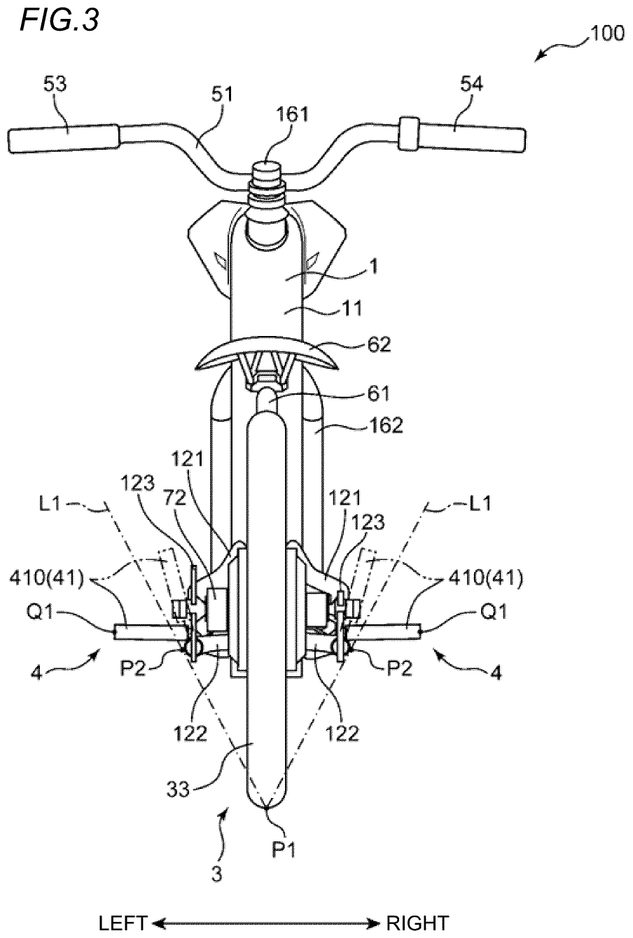

FIG. 1 is a schematic side view of a straddle type vehicle 100 according to an embodiment of the present disclosure. FIG. 2 is a schematic plan view of the straddle type vehicle 100. FIG. 3 is a schematic rear view of the straddle type vehicle 100.

The straddle type vehicle 100 includes a body frame 1, and a front wheel 2 and a rear wheel 3 which are rotatably supported by the body frame 1 separately. The straddle type vehicle 100 includes a pair of left and right steps 4 supported by the body frame 1. That is, the straddle type vehicle 100 includes steps 4 provided on one side and the other side of the body frame 1 in a vehicle width direction, respectively. The straddle type vehicle 100 includes a handle 5 and a seat 6 separately supported by the body frame 1. The straddle type vehicle 100 according to the present embodiment is an electric motorcycle that can be electrically driven by a motor 72, and includes the motor 72 as a drive source, a battery 74 that is a power storage device configured to supply electric power to the motor 72, and a controller 76 that controls rotation of the motor 72. Hereinafter, the straddle type vehicle 100 according to the present embodiment is referred to as an electric motorcycle 100.

The electric motorcycle 100 is capable of both electric traveling by the motor 72 and traveling with the motor 72 stopped. Specifically, unlike a bicycle that travels by pedaling (rotating pedals) with feet, the electric motorcycle 100 is configured such that a user, that is, a driver can obtain a propulsive force by kicking the ground. For example, when the user kicks the ground rearward while sitting on the seat 6 (saddle 62), a reaction force from the ground acts on the electric motorcycle 100 as a forward propulsive force, causing the electric motorcycle 100 to travel forward. In addition, when the motor 72 is driven, the electric motorcycle 100 can obtain a propulsive force from a rotational force of the motor 72, so that the user can travel without kicking the ground. Here, the electric motorcycle 100 is a one-person vehicle, and the only rider is the driver of the electric motorcycle 100.

As described above, the electric motorcycle 100 does not have a crank mechanism because a rider (driver) can obtain a propulsive force by kicking the ground. Specifically, in a bicycle that travels by pedaling with feet, a pedal is attached to the body frame via a crank mechanism so as to be rotatable about an axis extending in a left-right direction, and the wheels are rotated by rotating the pedal. On the other hand, the electric motorcycle 100 does not have a crank mechanism because it is not necessary to rotate the pedal to rotate the wheels.

The front wheel 2 includes an axle 21, a wheel main body 22, and a tire 23. The wheel main body 22 is attached to the axle 21 via a bearing. The tire 23 is a rubber component and is attached to an outer peripheral portion of the wheel main body 22. Similarly, the rear wheel 3 includes an axle 31, a wheel main body 32, and a tire 33. The wheel main body 32 is attached to the axle 31 via a bearing. The tire 33 is a rubber component and is attached to an outer peripheral portion of the wheel main body 32.

The motor 72 is coupled to the rear wheel 3. As described above, the motor 72 is an electric motor that rotates by receiving the electric power from the battery 74. The motor 72 mounted on the electric motorcycle 100 according to the present embodiment is a so-called in-wheel motor, and is coaxially attached to a central portion (hub) of the wheel main body 32 of the rear wheel 3 so as to directly rotate the rear wheel 3. Although not shown in detail, the motor 72 incorporates a stator that is non-rotatable with respect to the axle 31 and a rotor that rotates with respect to the stator when energized. The rotation of the rotor is transmitted to the wheel main body 32 via an output shaft coaxial with the wheel main body 32, thereby rotationally driving the rear wheel 3. In the electric motorcycle 100 according to the present embodiment, since the in-wheel motor is used as the motor 72 as described above, simplification and weight reduction of the drive system are achieved.

The body frame 1 is a frame forming a vehicle body of the electric motorcycle 100. The body frame 1 includes a main frame 11, a rear tube 12, a top tube 13, a seat tube 14, a head tube 15, and a front fork 16. In the electric motorcycle 100 according to the present embodiment, most of the body frame 1 is made of aluminum, thereby making the body frame 1 weighable.

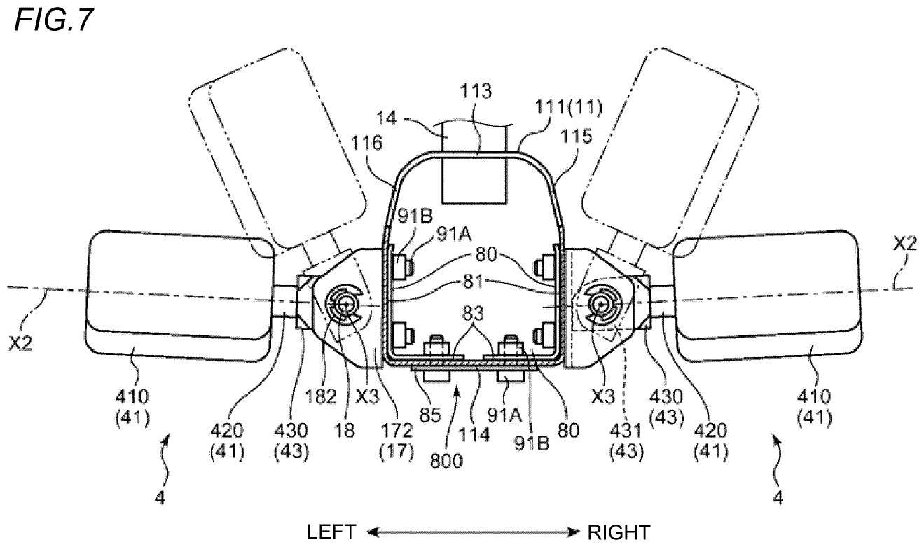

The main frame 11 is a hollow frame member extending rearward from above the front wheel 2 while inclining downward. A central axis X1 of the main frame 11 extends along a line inclined downward and rearward from above the front wheel 2. The main frame 11 includes a main body portion 111 extending along the central axis X1 and having a substantially rectangular cross section, and a rear wall 112 closing a rear end portion of the main body portion 111. Specifically, as shown in FIG. 7 to be described later, the main body portion 111 of the main frame 11 includes an upper wall 113 forming an upper surface thereof, a lower wall 114 forming a lower surface thereof, a right wall 115 extending in an upper-lower direction between right edges of the upper wall 113 and the lower wall 114, and a left wall 116 extending in the upper-lower direction between left edges of the upper wall 113 and the lower wall 114. The rear wall 112 of the main frame 11 closes a portion surrounded by rear edges of the upper wall 113, the lower wall 114, the right wall 115, and the left wall 116. The upper wall 113, the lower wall 114, the right wall 115, and the left wall 116 are integrally formed. For example, each of the walls 113 to 116, that is, the main body portion 111 is formed by bending one metal plate.

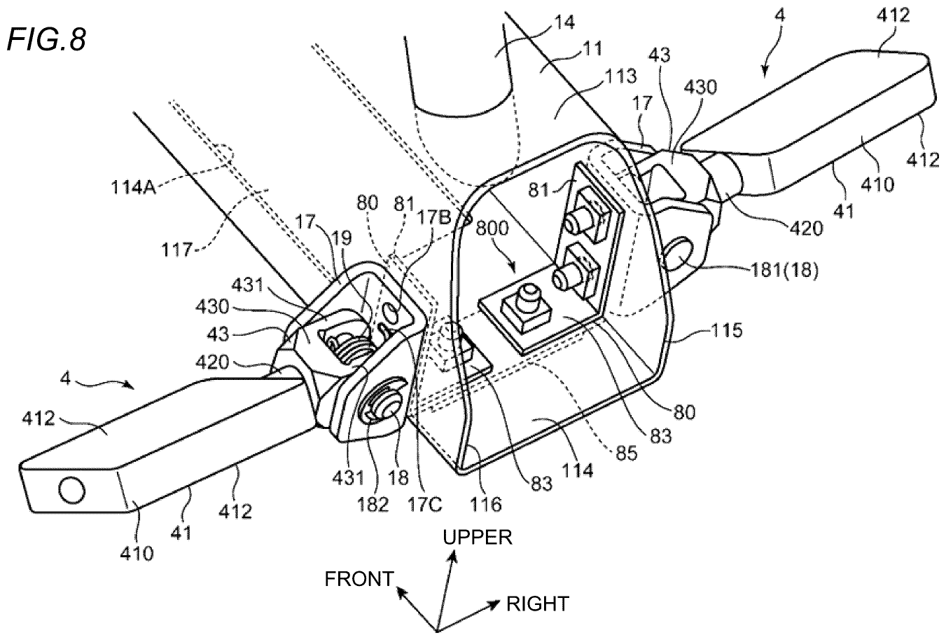

The battery 74 is accommodated inside the main frame 11. The controller 76 is fixed to a lower portion of the main frame 11 in a suspended state from the main frame 11. The controller 76 is fixed to the main frame 11 while being covered with a cover (not shown) made of resin or the like. An opening 114A (FIG. 8) through which the battery 74 is taken in and out is formed in the lower wall 114 of the main frame 11. A cover 117 that closes the opening 114A is detachably attached to the lower wall 114 via a screw or the like. The controller 76 may be accommodated inside the main frame 11.

The seat tube 14 is a pipe member extending upward from a rear end portion of the main frame 11. Specifically, the seat tube 14 extends upward from a portion of the main frame 11 behind a joint portion of the top tube 13. The seat tube 14 is joined to the main frame 11 by welding or the like in a state where a lower end portion thereof is inserted into the main frame 11 and a remaining portion thereof extends upward from the main frame 11.

The rear tube 12 includes a pair of left and right upper pipes 121, a pair of left and right lower pipes 122, and a pair of left and right end plates 123. The upper pipes 121 and the lower pipes 122 are each made of a pipe member. The pair of upper pipes 121 respectively extend rearward from the seat tube 14. The upper pipe 121 extends rearward from approximately the center of the seat tube 14 in the upper-lower direction. A front end portion of the upper pipe 121 is joined to the seat tube 14 by welding or the like. The lower pipe 122 extends rearward from the rear wall 112 of the main frame 11. A front end portion of the lower pipe 122 is joined to the main frame 11 by welding or the like. The end plate 123 is a plate-shaped member. Both ends of the axle 31 of the rear wheel 3 are fixed to the respective end plates 123 via fastening members or the like. Further, a rear end portion of each upper pipe 121 is joined to an upper portion of each end plate 123 by welding or the like, and a rear end portion of the lower pipe 122 is joined to a lower portion of each end plate 123 by welding or the like.

The top tube 13 is a pipe member extending in a front-rear direction. The top tube 13 extends in the front-rear direction between a substantially central portion of the main frame 11 in the front-rear direction (and the upper-lower direction) and an upper end portion of the seat tube 14, and is joined to the upper surface of the main frame 11 and a front surface of the seat tube 14 by welding or the like.

The head tube 15 is a substantially cylindrical pipe member extending in the upper-lower direction at a front end portion of the main frame 11. The head tube 15 is joined to the main frame 11 by welding or the like in a state where an intermediate portion thereof in the upper-lower direction is inserted into the main frame 11.

The front fork 16 includes a steering column 161 and a pair of left and right leg portions 162. The steering column 161 is a substantially cylindrical pipe member extending in the upper-lower direction. The steering column 161 is fixed to the head tube 15 in a state where an intermediate portion thereof is inserted into the head tube 15. The steering column 161 is coaxially inserted into the head tube 15 so as to be rotatable about a central axis thereof. The pair of leg portions 162 are pipe members that extend downward while branching to the left and right from a lower end portion of the steering column 161. The front wheel 2 is fixed to the front fork 16 by fastening both end portions of the axle 21 to lower end portions of the leg portions 162.

The seat 6 includes a seat post 61 and the saddle 62. The saddle 62 is a component that supports the buttocks of the rider of the electric motorcycle 100, and is detachably fixed to an upper end portion of the seat post 61. The seat post 61 is a pipe member extending in the upper-lower direction. At least a lower portion of the seat post 61 is coaxially inserted into the seat tube 14. The seat post 61 is held by the seat tube 14 so as to be slidable in the upper-lower direction. A clamp 63 for restricting sliding movement of the seat post 61 is attached to an upper end of the seat tube 14.

The handle 5 includes a handlebar 51, an accelerator grip 52, a brake side grip 53, and a brake lever 54. The handlebar 51 is a bar member extending in the left-right direction, and is fixed to an upper end portion of the front fork 16 (steering column 161) via a stem portion 55. When the handlebar 51 is steered in the front-rear direction, the front fork 16 rotates about the axes to change an orientation of the front wheel 2, and a traveling direction of the electric motorcycle 100 is changed. The accelerator grip 52 is a grip that is twisted and operated by the rider when driving the electric motorcycle 100 electrically, and is attached to cover a right side portion of the handlebar 51. The accelerator grip 52 is attached to the handlebar 51 so as to be rotatable about an axis extending in the left-right direction. The brake side grip 53 is a grip to be gripped by the left hand of the rider, and is attached to cover a left side portion of the handlebar 51. The brake lever 54 is a lever gripped and operated by the rider when decelerating the electric motorcycle 100. The brake lever 54 is attached to the handlebar 51 in a state of extending in the left-right direction in front of the brake side grip 53.

The accelerator grip 52 is electrically connected to the controller 76 via a cable (not shown). The controller 76 is electrically connected to the motor 72 via a cable (not shown). When the rider performs an operation of twisting the accelerator grip 52, a signal indicating an operation amount or the like of the twisting operation is input to the controller 76. The controller 76 controls power supply from the battery 74 to the motor 72 such that the motor 72 is driven to rotate at a desired rotation speed based on the input operation signal. The brake lever 54 is mechanically connected to a brake (not shown) attached to the rear tube 12 via a cable (not shown). When the rider performs an operation of gripping the brake lever 54, an operation force to the brake lever 54 is transmitted to the brake via the cable. Thus, a braking force for restricting the rotation of the rear wheel 3 is applied from the brake to the wheel main body 32 of the rear wheel 3. The cables are routed so as to pass through the inside of the main frame 11. A cable extending toward the brake and the motor 72 extends rearward from the main frame 11 through a through hole formed in the rear wall 112 of the main frame 11.

### (Step)

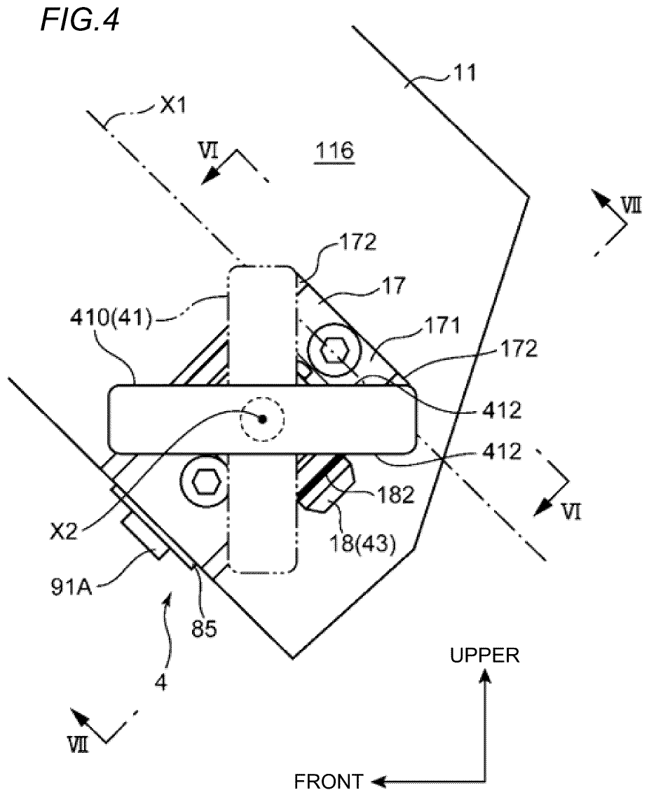

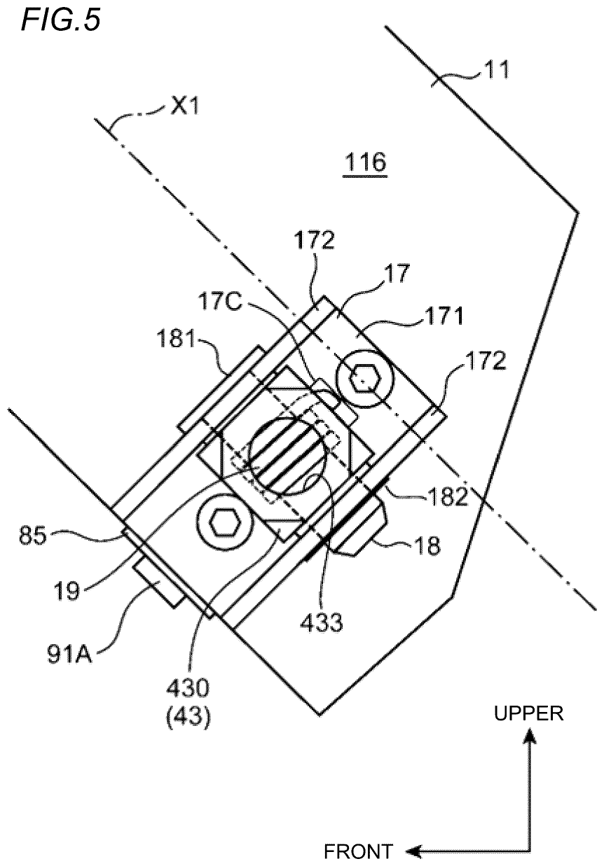

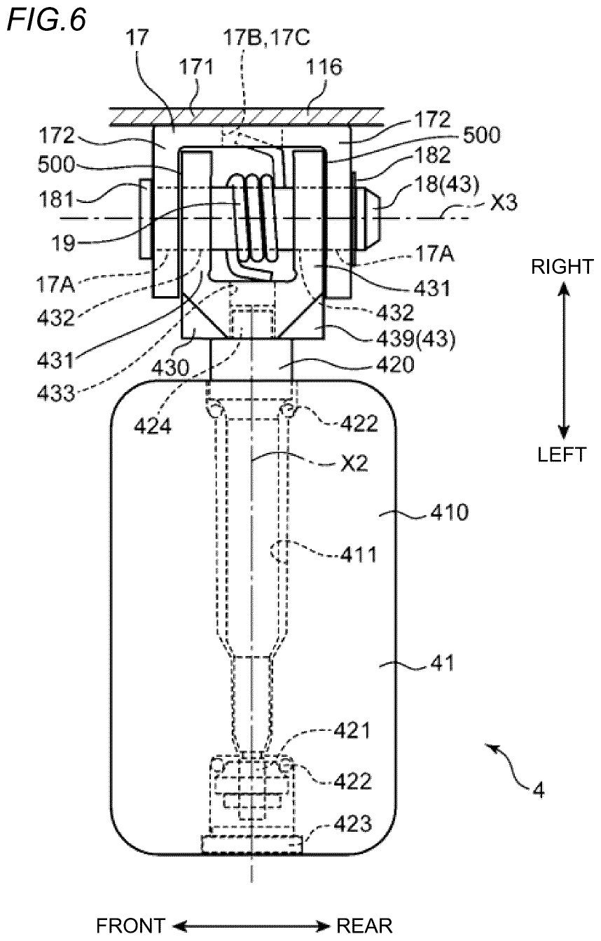

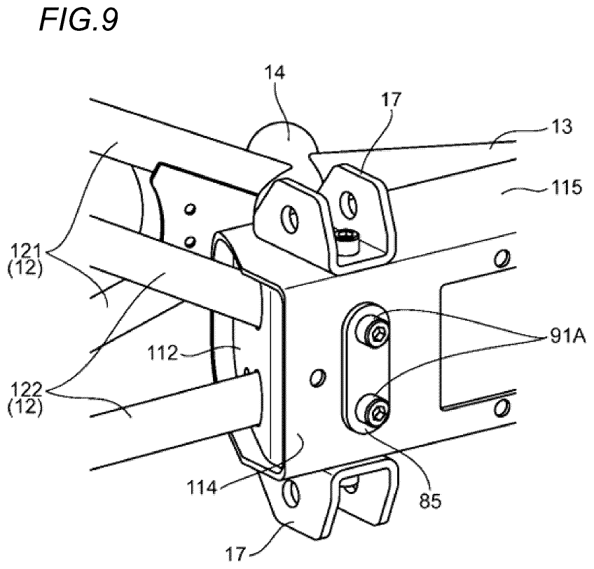

The step 4 will be described. FIG. 4 is an enlarged view of a part of FIG. 1. FIG. 5 is a view in which a step main body portion 41 to be described later is omitted from FIG. 4. FIG. 6 is a view showing a part of a cross section taken along a line VI-VI of FIG. 4. FIG. 7 is a view showing a part of a cross section taken along a line VII-VII of FIG. 4. FIG. 8 is a view of the vicinity of the rear end portion of the main frame 11 as viewed diagonally from the rear left. In FIG. 8, the rear wall 112 of the main frame 11 is omitted. FIG. 9 is a view of the vicinity of the rear end portion of the main frame 11 as viewed diagonally from the lower right. FIG. 9 is a view showing a coupling plate 85 of a reinforcing member 800 to be described later, and illustration of the step 4 and the like is omitted.

First, a structure of the step 4 will be described. The two steps 4 have the same structure and are supported by the main frame 11 in a bilaterally symmetrical posture. The two steps 4 each include a step main body portion 41 and a base end portion 43. The step main body portion 41 includes substantially rectangular parallelepiped footrest portions 410 and step shafts 420. Hereinafter, as shown in FIGS. 1 and 2, the steps 4 will be described using a direction in which the steps 4 extend outward in the left-right direction from the main frame 11 and a pair of outer side surfaces having the largest area among the outer side surfaces of the footrest portions 410 are orthogonal to the upper-lower direction.

The step shaft 420 is a member extending in the left-right direction. The footrest portion 410 is a substantially rectangular parallelepiped member extending in the left-right direction. Specifically, the footrest portion 410 has a substantially rectangular parallelepiped shape in which the dimension in the front-rear direction is larger than the dimension in a height direction and the dimension in the left-right direction is larger than the dimension in the front-rear direction. In the illustrated example, the dimension of the footrest portion 410 in the front-rear direction is set to approximately five times the dimension in the height direction, and the dimension of the footrest portion 410 in the left-right direction is set to approximately twice the dimension in the front-rear direction.

The footrest portion 410 is coupled to the step shaft 420 so as to be rotatable about a central axis X2 extending in the left-right direction. The footrest portion 410 can rotate 360 degrees or more both clockwise and counterclockwise. The chain line in FIG. 4 shows a state in which the footrest portion 410 is rotated by 90 degrees from the state shown by the solid line.

Specifically, in the electric motorcycle 100 according to the present embodiment, a step shaft attachment hole 411 extending along the central axis X2 and penetrating the footrest portion 410 in the left-right direction is formed in the footrest portion 410. A threaded portion 421 having a thread formed on an outer peripheral surface thereof is provided at an outer end portion of the step shaft 420 in the left-right direction. The step shaft 420 is inserted into the step shaft attachment hole 411 of the footrest portion 410 in a state where the central axis of the step shaft 420 coincides with the central axis X2 of the footrest portion 410. In this inserted state, a nut is fastened to the threaded portion 421 of the step shaft 420. Accordingly, the footrest portion 410 is coupled to the step shaft 420 in a rotatable state around the step shaft 420 and the central axis X2 of the footrest portion 410. Further, bearings 422 are disposed on one end portion and the other end portion of the step shaft attachment hole 411 in the left-right direction, respectively. Thus, the footrest portion 410 is smoothly rotatable about the central axis X2. In the illustrated example, a cap 423 is attached to an outer end portion of the step shaft attachment hole 411 in the left-right direction to close the step shaft attachment hole 411.

Since the footrest portion 410 is rotatable about the central axis X2 by 360 degrees or more as described above, both an upper surface and a lower surface of the footrest portion 410 can face the saddle 62. That is, the rider seated on the seat 6 (saddle 62) can place the feet on both the upper surface and the lower surface of the footrest portions 410. Thus, both the upper surface and the lower surface of the footrest portion 410 function as a footrest surface 412 on which the rider places the feet. In other words, the footrest portion 410 has a pair of upper and lower footrest surfaces 412. Since the dimensions of the footrest portion 410 are set as described above, the footrest surface 412 of the footrest portion 410 has a shape extending in the front-rear direction and extending in the left-right direction.

The base end portion 43 includes a step main body attachment portion 439 to which the step main body portion 41 is attached, and a shaft 18. The shaft 18 corresponds to a “rotation shaft” in the present disclosure.

The step main body attachment portion 439 includes a substantially rectangular parallelepiped block portion 430 extending in the front-rear direction, and a pair of front and rear arm portions 431 extending inward in the left-right direction from the block portion 430. The block portion 430 and the two arm portions 431 are formed integrally with each other. Each of the pair of arm portions 431 has a plate shape extending along a plane orthogonal to the central axis X1 of the main frame 11. The pair of arm portions 431 extend parallel to each other at positions separated from each other in the front-rear direction. The pair of arm portions 431 are respectively formed with shaft insertion holes 432 and 432 penetrating therethrough in the front-rear direction. The center lines of the two shaft insertion holes 432, 432 extend along the same line extending parallel to the central axis X1 of the main frame 11.

The shaft 18 is a substantially cylindrical member. The shaft 18 has a head portion 181 having a diameter larger than that of the other portion on one end portion in an axial direction. A groove (not shown) is formed on the other end portion of the shaft 18 in the axial direction. As described later, the shaft 18 is inserted into the shaft insertion holes 432, 432 of the arm portions 431.

The block portion 430 is formed with a bolt hole 433 penetrating therethrough in the left-right direction. A threaded portion 424 having a thread formed on an outer peripheral surface thereof is provided at an inner side portion of the step shaft 420 in the left-right direction. The threaded portion 424 of the step shaft 420 is screwed into the bolt hole 433 of the block portion 430. Therefore, the step main body portion 41 is coupled to the step main body attachment portion 439 and thus to the base end portion 43 in a state of extending outward from the step main body attachment portion 439 in the left-right direction.

Next, a support structure of the step 4 will be described.

The base end portions 43 are coupled to brackets 17 fixed to the main frame 11, and the steps 4 are supported by the main frame 11 via the brackets 17. Specifically, the right step 4 is coupled to the bracket 17 fixed to the right wall 115 of the main frame 11, and the left step 4 is coupled to the bracket 17 fixed to the left wall 116 of the main frame 11. The right bracket 17 and the left bracket 17 have the same structure, and are fixed to the main frame 11 in a bilaterally symmetrical posture. That is, the body frame 1 includes a pair of left and right brackets 17 fixed to the main frame 11 and coupling the main frame 11 and the steps 4. In the electric motorcycle 100 according to the present embodiment, the brackets 17 and thus the steps 4 are fixed (supported) to a lower portion of the rear end portion of the main frame 11. A portion of the main frame 11 to which the brackets 17 are fixed and a portion of the main frame 11 to which the seat tube 14 is joined are positioned at substantially the same position in the front-rear direction.

The steps 4 are supported by the main frame 11 such that the steps 4 can be rotated in the upper-lower direction between a first posture in which the step main body portion 41 extends outward in the left-right direction from the main frame 11 as shown by the solid line in FIGS. 3 and 7, and a second posture in which the step main body portion 41 extends upward from the main frame 11 as shown by the chain line in FIGS. 3 and 7. In the electric motorcycle 100 according to the present embodiment, the step main body portion 41 rotates about an axis substantially parallel to the central axis X1 of the main frame 11, and rotates diagonally rearward and upward from the first posture toward the second posture.

When the step main body portions 41 are in the first posture, as shown by the solid line in FIG. 3, that is, as viewed along the front-rear direction, the step main body portions 41 are in a state in which outer ends Q1 thereof in the left-right direction are respectively positioned on an outer side in the left-right direction than virtual lines L1 connecting a ground contact point P1 of the rear wheel 3 and outer ends P2 of the body frame 1 in the left-right direction. In other words, in the first posture, the step main body portions 41 extend outward in the left-right direction from the main frame 11, and when viewed along the front-rear direction, the outer ends Q1 of the step main body portion 41 in the left-right direction are located on the outer side in the left-right direction than the virtual lines L1. When the step main body portion 41 is in the first posture, as shown by the solid line in FIG. 2 or the like, that is, as viewed along the upper-lower direction, the step main body portion 41 is in a state where the central axis X2 of the footrest portion 410 and the central axis X1 of the main frame 11 are substantially orthogonal to each other. When the step main body portion 41 is in the first posture, as shown by the solid line in FIG. 7 or the like, that is, as viewed along the central axis X1 of the main frame 11, the step main body portion 41 is in a state where the central axis X2 of the footrest portion 410 is slightly inclined outwardly and upwardly.

On the other hand, when the step main body portions 41 are in the second posture, as shown by the chain line in FIG. 3, that is, as viewed along the front-rear direction, the step main body portions 41 are in a state in which outer ends Q1 thereof in the left-right direction are respectively positioned on an inner side in the left-right direction than the virtual lines L1. In other words, in the second posture, the step main body portions 41 extend upward from the main frame 11, and when viewed along the front-rear direction, the outer ends Q1 of the step main body portions 41 in the left-right direction are located inward in the left-right direction than the virtual lines L1. When the step main body portion 41 is in the second posture, as shown by the chain line in FIG. 2 or the like, that is, as viewed along the upper-lower direction, the step main body portion 41 is in a state where the central axis X2 of the footrest portion 410 is slightly inclined outwardly and rearward.

In the electric motorcycle 100 according to the present embodiment, the above-described support structure is achieved by the following configuration.

The bracket 17 has a substantially U-shaped cross section. The bracket 17 includes a vertical wall 171 extending along an outer side surface of the main frame 11 in the left-right direction (right side surface of the right wall 115 of the main frame 11 for the right bracket 17, left side surface of the left wall 116 of the main frame 11 for the left bracket 17). The bracket 17 includes a pair of front and rear horizontal walls 172 extending outward in the left-right direction from a front edge and a rear edge of the vertical wall 171, respectively.

Bolt holes 17B, 17B are provided in an upper end portion and a lower end portion of the vertical wall 171 of the bracket 17. The bracket 17 is fixed to the main frame 11 by bolts 91A inserted into the bolt holes 17B, 17B and nuts 91B screwed onto the bolts 91A.

The horizontal wall 172 has a plate shape extending along a plane orthogonal to the central axis X1 of the main frame 11. Shaft insertion holes 17A, 17A are formed through the pair of horizontal walls 172 in the front-rear direction, respectively. The center lines of the shaft insertion holes 17A, 17A extend along the same line extending parallel to the central axis X1 of the main frame 11.

The two arm portions 431 of the step main body attachment portion 439 of the base end portion 43 are disposed between the front horizontal wall 172 and the rear horizontal wall 172 of the bracket 17. The shaft 18 of the base end portion 43 is fixed to the bracket 17 in a state where the shaft 18 is commonly inserted into the shaft insertion holes 432, 432 of the arm portions 431 of the step main body attachment portion 439 and into the shaft insertion holes 17A, 17A of the bracket 17. Specifically, the shaft 18 is inserted into the four shaft insertion holes 17A, 17A, 432, and 432 with both end portions in the axial direction of the shaft 18 protruding outward in the front-rear direction from each horizontal wall 172 of the bracket 17. In this inserted state, a clip 182 is fitted into the groove formed in the end portion of the shaft 18, thereby fixing the shaft 18 to the bracket 17. The shaft 18 is fixed such that a central axis X3 thereof extends substantially parallel to the central axis X1 of the main frame 11. Further, a diameter of each of the shaft insertion holes 17A, 432 is set to be substantially the same as a diameter of the portion of the shaft 18 that is inserted through these holes. A washer 500 is disposed between each arm portion 431 and the horizontal walls 172 of each bracket 17.

As shown in FIG. 5, the arm portion 431 of the step main body attachment portion 439 has a substantially rectangular shape as a whole. In a state where the step 4 is in the first posture, a portion positioned on the lower side and an inner side in the left-right direction of the arm portion 431 forms a substantially roughly right-angled corner, while a portion positioned on the upper side and the inner side in the left-right direction of the arm portion 431 is formed in an arc shape that bulges inward in the left-right direction. That is, a lower portion of an inner edge in the left-right direction of the arm portion 431 extends straight in the upper-lower direction, while an upper portion is curved outward in the left-right direction and upward. With this configuration, due to the contact between the bracket 17 and the inner edge in the left-right direction of the arm portion 431, the step main body portion 41 in the first posture cannot be rotated downward. On the other hand, the step main body portion 41 in the first posture can be rotated upward.

With the above configuration, in a state where the step main body portion 41 is rotatable about the shaft 18, that is, about the central axis X3 of the shaft 18, which is substantially parallel to the central axis X1 of the main frame 11, the step 4 is coupled to the bracket 17 and supported by the main frame 11 via the bracket 17. Further, the step main body portion 41 is rotatable only between the first posture and the second posture in which the step main body portion 41 is rotated upward.

Here, in the electric motorcycle 100 according to the present embodiment, a biasing member that biases the step main body portion 41 to the first posture is provided, and the step main body portion 41 is maintained in the first posture unless an upward force of a predetermined value or more is applied. Specifically, a coil spring 19 is wound around the shaft 18 as the biasing member. The vertical wall 171 of the bracket 17 is provided with a spring locking hole 17C penetrating the vertical wall 171 in the left-right direction. One end of the coil spring 19 is locked to the spring locking hole 17C, and the other end of the coil spring 19 is pressed against an inner side surface in the left-right direction of the block portion 430 of the step main body attachment portion 439 and locked to the inner side surface. With this configuration, when the step main body portion 41 is rotated upward from the first posture, the coil spring 19 contracts and applies an elastic force, that is, a biasing force to the step main body portion 41 via the step main body attachment portion 439 in a direction toward the first posture.

In the electric motorcycle 100 according to the present embodiment, the vehicle body frame 10 includes the reinforcing member 800 for reinforcing a portion of the main frame 11 that supports the step 4, that is, the portion to which the bracket 17 is fixed. The reinforcing member 800 includes a pair of left and right reinforcing plates 80 and the coupling plate 85 that couples the reinforcing plates 80 to each other.

The two reinforcing plates 80 have a symmetrical structure in the left-right direction. Each of the two reinforcing plates 80 has a substantially L-shape, and includes a vertical wall 81 extending in the upper-lower direction along the side wall in the left-right direction of the main frame 11 (the right wall 115 for the right reinforcing plate 80, the left wall 116 for the left reinforcing plate 80), and a horizontal wall 83 extending inward in the left-right direction from a lower edge of the vertical wall 81. The vertical wall 81 and the horizontal wall 83 forming the reinforcing plate 80 are integrally formed. The reinforcing plates 80 and the coupling plate 85 are made of, for example, iron. The vertical walls 81 of the reinforcing plates 80 are fixed to the side wall in the left-right direction of the main frame 11 by bolts 91A and nuts 91B together with the bracket 17.

The coupling plate 85 has a plate shape extending in the left-right direction along a lower surface of the lower wall 114 of the main frame 11. The coupling plate 85 is disposed at a position facing the horizontal walls 83, 83 of the two reinforcing plates 80, and is disposed so as to couple the horizontal walls 83, 83. The coupling plate 85 is fixed to the lower wall 114 of the main frame 11 together with the horizontal walls 83, 83 of the two reinforcing plates 80 by the bolts 91A and the nuts 91B.

The reinforcing plate 80 suppresses deformation of a part of the main frame 11 to which the bracket 17 is fixed, and the coupling plate 85 couples the reinforcing plates 80 to each other to suppress such deformation.

### (Operation and Effect)

As described above, the electric motorcycle 100 according to the above embodiment does not include a crank mechanism as described above, and does not require the rider to pedal with the feet in order to travel. That is, the electric motorcycle 100 according to the above embodiment does not require a pedal for traveling. However, in the straddle type vehicle in which the pedal is omitted, there are many chances that the rider has to lift the feet by his/her own, making it difficult to provide good ride comfort. In contrast, in the electric motorcycle 100 according to the above embodiment, the pair of left and right steps 4 each having the footrest surface 412 are supported by the main frame 11. Therefore, a rider can travel in a state where the right and left feet are placed on the footrest surfaces 412 of the steps 4. That is, according to the electric motorcycle 100 of the above embodiment, it is possible to reduce the chances that the rider has to lift the feet by his/her own. Accordingly, the electric motorcycle 100 with good ride comfort is achieved.

Further, in the electric motorcycle 100 according to the above embodiment, the base end portions 43 are supported by the main frame 11 in a non-rotatable manner about the axis extending in the left-right direction, while the step main body portions 41 each including the footrest surface 412 is rotatable about the axis X2 extending in the left-right direction. Therefore, an orientation of the footrest surface 412 can be changed in accordance with the orientation of the soles of the rider, and the feet of the rider can be stably supported regardless of the orientation of the soles of the rider.

Here, when the steps 4 are provided as described above, a load of the rider is applied to a portion of the main frame 11 that supports the steps 4. In this regard, in the electric motorcycle 100 according to the above embodiment, the portion of the main frame 11 that supports the steps 4, specifically, the portion fixed with the bracket 17 to which the step 4 is coupled is reinforced by the reinforcing member 800. Therefore, the support rigidity of the steps 4 can be increased. Further, deformation of the main frame 11 can be prevented. In particular, in the electric motorcycle 100 according to the above-described embodiment, the reinforcing member 800 is provided inside the main frame 11. Therefore, it is possible to improve the support rigidity of the steps 4 while improving the appearance of the main frame 11.

In the electric motorcycle 100 according to the above embodiment, the step main body portion 41 is rotatable between the first posture indicated by the solid line in FIG. 3 in a manner of extending outward in the left-right direction from the main frame 11, and the second posture indicated by the chain line in FIG. 3 in a manner of extending upward from the main frame 11.

Therefore, by setting the posture of the step main body portion 41 in the first posture, it is possible to stably support the feet of the rider, and to prevent the step main body portion 41 from coming into contact with the ground when the vehicle body is tilted. Here, when the vehicle body is tilted, if the outer end of the step main body portion 41 in the left-right direction, that is, the end portion Q1 on the outer side in the left-right direction comes into contact with the ground, the vehicle body may tilt about the outer end Q1 as a fulcrum, and the wheels 2 and 3 may lift off the ground. Therefore, according to the electric motorcycle 100 of the embodiment, even when the vehicle body is tilted, the contact between the wheels 2 and 3 and the ground can be maintained. Further, it is possible to prevent the step main body portion 41 from being damaged due to contact between the step main body portion 41 and the ground.

In particular, in the electric motorcycle 100 according to the above embodiment, the step main body portion 41 can rotate to the second posture in which the outer ends Q1 thereof in the left-right direction are respectively positioned on the inner side in the left-right direction with respect to the virtual lines L1 connecting the ground contact point P1 of the rear wheel 3 and the outer ends P2 of the body frame 1 in the left-right direction, that is, the end portions P2 on the outer side in the left-right direction. Therefore, contact between the step main body portion 41 and the ground can be further prevented.

In the electric motorcycle 100 according to the above embodiment, the shaft 18 is disposed such that the central axis X3 thereof extends substantially parallel to the central axis X1 of the main frame 11, which extends rearward from above the front wheel 2 while inclining downward, and the step main body portion 41 rotates about the central axis X3 of the shaft 18. That is, the step main body portions 41 rotate about an axis parallel to the central axis X1 of the main frame 11 extending as described above. Along with this, the step main body portions 41 rotate rearward and diagonally upward from the first posture toward the second posture. Accordingly, it is possible to prevent the step main body portion 41 from interfering with the feet of the rider when the step main body portion 41 rotates toward the second posture.

Further, in the electric motorcycle 100 according to the above embodiment, the step main body portion 41 is biased by the coil spring 19 in the direction toward the first posture. Therefore, even when the step main body portion 41 is rotated upward with respect to the first posture by receiving an upward load, after the load is removed, the step main body portion 41 can be quickly returned to the first posture in which the step main body portion 41 can support the feet of the rider. Accordingly, it is possible to prevent the rider from losing the balance due to missing the step 4.

### (Modifications)

A specific coupling structure between the step main body portion 41 and the base end portion 43 is not limited to the above as long as the step main body portion 41 and the base end portion 43 are coupled in a state in which the step main body portion 41 is connected to the base end portion 43 in a relatively rotatable manner around an axis extending in the left-right direction.

A specific coupling structure between the base end portion 43 and the main frame 11 is not limited to the above as long as the step main body portion 41 is coupled so as to be rotatable between the first posture in which the step main body portion 41 extends outward in the left-right direction from the main frame 11 and the second posture in which the step main body portion 41 extends upward from the main frame 11.

For example, in the above embodiment, the case has been described in which the step main body portion 41 rotates about the axis X3 which is the central axis X3 of the shaft 18 and is parallel to the central axis X1 of the main frame 11. Alternatively, the rotation axis of the step main body portion 41 may not be parallel to the central axis X1 of the main frame 11.

Further, in the embodiment described above, the case has been described in which the second posture is a posture in which the outer ends Q1 of the step main body portions 41 in the left-right direction are located inward in the left-right direction than the virtual lines L1. Alternatively, the second posture may be a posture in which the step main body portions 41 extend upward from the main frame 11. That is, the second posture may be a posture in which the outer ends Q1 of the step main body portions 41 in the left-right direction are located outside the virtual lines L1 in the left-right direction.

Further, in the embodiment described above, the case has been described in which the base end portion 43 is supported by the main frame 11 via the bracket 17. Alternatively, the base end portion 43, and further the step 4 may be directly attached to the main frame 11.

Further, the specific configuration of the reinforcing member for reinforcing the portion of the main frame 11 to which the bracket 17 is fixed is not limited to the above. For example, in the above exemplary embodiment, the case has been described in which the pair of left and right reinforcing plates 80 are provided. Alternatively, the two reinforcing plates 80 may be integrated and configured as a single member. Alternatively, a member extending in the left-right direction and connecting the base end portions 43 of the two steps 4 may be provided as the reinforcing member. Alternatively, the reinforcing member may be omitted.

In the above embodiment, only the motor 72 for driving the rear wheel 3 is provided as the drive source for electric traveling. Alternatively, the drive source may be any source that drives at least one of the front wheel and the rear wheel. That is, the drive source may be a motor that drives only the front wheel or may be a motor that drives both the front wheel and the rear wheel.

Further, in the embodiment described above, the motor 72, which is an in-wheel motor that is coaxially attached to the wheel, is provided as a drive source for electric traveling. Alternatively, the drive source may not be the in-wheel motor. For example, a motor interlockingly connected to an axle via a gear or the like may be attached non-coaxially to the wheel.

Further, in the embodiment described above, the straddle type vehicle is shown as an electric vehicle capable of electric driving using the motor 72, and the straddle type vehicle is not limited to an electric vehicle. That is, the straddle type vehicle may be a vehicle that does not include a motor, a battery, or the like, that is, a vehicle that can only travel by kicking.

### (Summary)

The embodiment and their modifications are summarized as follows.

A straddle type vehicle includes: a front wheel and a rear wheel; a body frame rotatably supporting the front wheel and the rear wheel; and a pair of left and right steps supported by the body frame, in which the steps each include a base end portion attached to the body frame in a state in which rotation about an axis extending in the left-right direction is disabled, and a step main body portion having a footrest surface, extending outward in the left-right direction from the base end portion, and coupled to the base end portion in a state of being rotatable about the axis extending in the left-right direction.

In this configuration, the pair of left and right steps each having the footrest surface are supported by the body frame. Therefore, the left and right feet of the rider can be supported by the steps. Accordingly, it is possible to reduce the chances that the rider has to lift the feet by his/her own, and to improve the ride comfort. In particular, the base end portion of the step is attached to the body frame in a non-rotatable manner about the axis extending in the left-right direction, and the step as a whole is non-rotatable about the axis extending in the left-right direction. That is, the step main body portion having the footrest surface is attached to the body frame without a crank mechanism. Thus, according to this configuration, the right and left feet of the rider can be supported in the straddle type vehicle having no crank mechanism, and the ride comfort can be improved in the straddle type vehicle.

In addition, the step as a whole is non-rotatable about the axis extending in the left-right direction, while the step main body portion including the footrest surface is rotatable about the axis extending in the left-right direction. Therefore, an orientation of the footrest surface can be changed in accordance with the orientation of the soles of the rider. Accordingly, the feet of the rider can be stably supported regardless of the orientation of the soles of the rider.

Preferably, the base end portion includes a rotation shaft configured to rotate the step main body portion between a first posture in which the step main body portion extends outward from the body frame in the left-right direction and a second posture in which the step main body portion extends upward from the body frame.

In this configuration, the posture of the step main body portion can be switched between the first posture in which the feet of the rider can be supported and the second posture in which an amount of protrusion of the step main body portion outward in the left-right direction from the body frame is small. Therefore, it is possible to prevent the step main body portion from coming into contact with the ground when the vehicle body is tilted while improving the ride comfort of the rider during normal traveling. Since the step main body portion can be prevented from coming into contact with the ground, damage to the step main body portion can be prevented, and the vehicle body can be prevented from tilting with the step main body portion as a reference point and the wheels can be prevented from lifting off the ground.

Preferably, the first posture is a posture in which an outer end of the step main body portion in the left-right direction is located on an outer side in the left-right direction than a virtual line connecting a ground contact point of the rear wheel and an outer end of the body frame in the left-right direction when viewed along a front-rear direction, and the second posture is a posture in which the outer end of the step main body portion in the left-right direction is located on an inner side in the left-right direction than the virtual line when viewed along the front-rear direction.

According to this configuration, it is possible to further reduce the chances that the step main body portion comes into contact with the ground when the vehicle body is tilted, to further suppress damage to the step main body portion, and to further reduce the chances that the wheels are lifted off the ground.

Preferably, a biasing member configured to bias the step main body portion such that the step main body portion rotates toward the first posture is provided.

According to this configuration, a basic posture of the step main body portion can be set to the first posture, and it is possible to prevent the rider from missing the steps.

Preferably, the body frame includes a main frame extending rearward while inclining downward from above the front wheel, and the rotation shaft rotates the step main body portion about an axis parallel to the main frame.

According to this configuration, the step main body portion can be rotated rearward and diagonally upward from the first posture toward the second posture. Therefore, it is possible to prevent the step main body portion from interfering with the feet of the rider when the step main body portion is rotated.

Preferably, the body frame includes a hollow main frame supporting the step, and a reinforcing member disposed inside the main frame to reinforce a portion of the main frame that supports the step.

According to this configuration, the support rigidity of the step with respect to the main frame can be increased.

What is claimed is:

1. A straddle type vehicle comprising:
a front wheel and a rear wheel;
a body frame rotatably supporting the front wheel and the rear wheel; and
a pair of left and right steps supported by the body frame, wherein
the steps each include a base end portion attached to the body frame without rotating about an axis extending in a left-right direction of the body frame, and a step main body portion having a footrest surface configured to support feet of a rider, and
the step main body portion extends outward in the left-right direction from the base end portion, and is coupled to the base end portion in a state of being rotatable about the axis extending in the left-right direction.

2. The straddle type vehicle according to claim 1, wherein
the base end portion includes a rotation shaft configured to rotate the step main body portion between a first posture in which the step main body portion extends outward from the body frame in the left-right direction and a second posture in which the step main body portion extends upward from the body frame.

3. The straddle type vehicle according to claim 2, wherein
the first posture is a posture in which an outer end of the step main body portion in the left-right direction is located on an outer side in the left-right direction than a virtual line connecting a ground contact point of the rear wheel and an outer end of the body frame in the left-right direction when viewed along a front-rear direction of the body frame, and
the second posture is a posture in which the outer end of the step main body portion in the left-right direction is located on an inner side in the left-right direction than the virtual line when viewed along the front-rear direction.

4. The straddle type vehicle according to claim 3, further comprising:
a biasing member configured to bias the step main body portion such that the step main body portion rotates toward the first posture.

5. The straddle type vehicle according to claim 2, wherein
the body frame includes a main frame extending rearward while inclining downward from above the front wheel, and
the rotation shaft rotates the step main body portion about an axis parallel to the main frame.

6. The straddle type vehicle according to claim 1, wherein
the body frame includes a hollow main frame supporting the step, and a reinforcing member disposed inside the main frame to reinforce a portion of the main frame that supports the step.

7. The straddle type vehicle according to claim 2, wherein
the body frame includes a main frame extending rearward while inclining downward from above the front wheel, and
a central axis of the rotation shaft is fixed to extend substantially parallel to a central axis of the main frame.

8. The straddle type vehicle according to claim 1, wherein
the step includes a step shaft extending in the left-right direction, and
the step main body portion and the base end portion are connected to each other via the step shaft.
